(19) United States
(12) Patent Application Publication
(10) Pub. No.: US 2005/0113280 A1
(43) Pub. Date: May 26, 2005

(54) Laundry compositions having copolymers containing polyalkylene oxide groups and quaternary nitrogen atoms and a surfactant system

(76) Inventors: Pramod Kakumanu Reddy, Heidelberg (DE); Xinbei Song, Cincinnati, OH (US); Jurgen Detering, Limburgerhof (DE); Thomas Pheiffer, Bohl-Iggelheim (DE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/993,889

(22) Filed: Nov. 21, 2004

Related U.S. Application Data
(60) Provisional application No. 60/524,370, filed on Nov. 21, 2003.

(51) Int. Cl. C11D 3/37

(52) U.S. Cl. 510/475

(57) ABSTRACT

A detergent composition having a copolymer containing polyalkylene oxide groups and quaternary nitrogen atoms and a surfactant system for clay soil removal and anti-redeposition benefits on surfaces such as fabrics and hard surfaces.

### CROSS-REFERENCE

This application claims priority under 35 U.S.C. § 119(e) to U.S. provisional application No. 60/524370, filed Nov. 21, 2003.

### FIELD OF INVENTION

The present invention relates to a detergent composition comprising a copolymer comprising polyalkylene oxide groups and quaternary nitrogen atoms for clay soil removal and anti-redeposition benefits on surfaces such as fabrics and hard surfaces, such as floors or dishes.

### BACKGROUND OF THE INVENTION

In the washing process, a distinction is drawn between primary and secondary detergency. Primary detergency is understood as meaning the actual removal of soiling from the textile or hard surface. Secondary detergency is understood as meaning the prevention of the effects, which arise as a result of the redeposition of the detached soiling from the wash liquor onto a surface such as fabrics or hard surfaces. In the case of fabrics, the fabrics often become increasingly gray from washing operations and the resulting graying process is rarely reversed. In the case of hard surfaces, such as floors, redeposition leads to streaking and/or spotting of the hard surfaces, which is undesirable to consumers.

It is known to use materials such as sodium salts of carboxymethylcellulose (CMC) Polyacrylic acids and acrylic acid-maleic acid copolymers for preventing redeposition of soiling from the wash liquor onto a surface such as fabric. However, the action of known polymers is not satisfactory for clay-containing soiling.

The detergent composition comprising the copolymers according to the invention provide the following advantageous application properties: the detergent compositions disperse particles of soiling in an excellent manner and thus prevent redeposition of the soiling onto the fabric and hard surfaces during washing. This benefit applies particularly for particulate soilings, but also hydrophobic, oil- and grease-containing soilings. In particular, earth-like soilings can be removed easily as a result of the use of the detergent composition according to the invention.

### SUMMARY OF THE INVENTION

The present invention relates to a detergent composition comprising: from about 0.005 to about 20% by weight of the detergent composition of a copolymer which comprises, in pre-copolymerized form, monomer (I) comprising from about 60 to about 99% by weight of the copolymer of at least one monoethylenically unsaturated polyalkylene oxide monomer of the formula I: 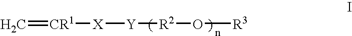
wherein Y of formula (I) is selected from —O— and —NH—; , if Y of formula (I) is —O—, X of formula (I) is selected from —CH₂— or —CO—, -if Y of formula (I) is —NH—, X of formula (I) is —CO—; R¹ of formula (I) is selected from hydrogen, methyl, and mixtures thereof; R² of formula (I) is independently selected from linear or branched C₂-C₆-alkylene radicals, which may be arranged blockwise or randomly; R³ of formula (I) is selected from hydrogen, C₁-C₄-alkyl, and mixtures thereof; n of formula (I) is an integer from 3 to 50;

monomer (II) comprising from about 1 to about 40% by weight of at least one quaternized nitrogen-containing monoethylenically unsaturated monomer,
monomer (III) comprising from 0 to about 39% by weight of the copolymer of anionic monoethylenically unsaturated monomers; and
monomer (IV) comprising from 0 to about 30% by weight of the copolymer of other nonionic monoethylenically unsaturated monomers;
wherein the copolymer has an average molecular weight M_{w} of from 2000 to 100000.

The detergent composition further comprises from about 0.01% to about 90% by weight of the detergent composition of a surfactant system having one or more surfactants selected from anionic surfactants, nonionic surfactants, cationic surfactants, zwitterionic surfactants, amphoteric surfactants, and mixtures thereof.

The present invention further relates to a method of using the detergent composition for cleaning a surface by contacting the detergent composition of Claim 1 with at least a portion of a surface, and then optionally rinsing the surface. The detergent composition of the present invention is preferably a laundry detergent composition or a hard surface detergent composition.

All documents cited are, in relevant part, incorporated herein by reference; the citation of any document is not to be construed as an admission that it is prior art with respect to the present invention.

### DETAILED DESCRIPTION OF THE INVENTION

The present invention relates to a detergent composition comprising copolymers containing polyalkylene oxide groups and quaternary nitrogen atoms. These compositions can be in any conventional form, namely, in the form of a liquid, powder, granules, agglomerate, paste, tablet, pouches, bar, gel, types delivered in dual-compartment containers, spray or foam detergents, premoistened wipes (i.e., the detergent composition in combination with a nonwoven material such as that discussed in U.S. Pat. No. 6,121,165, Mackey, et al.), dry wipes (i.e., the detergent composition in combination with a nonwoven materials, such as that discussed in U.S. Pat. No. 5,980,931, Fowler, et al.) activated with water by a consumer, and other homogeneous or multiphase consumer cleaning product forms. In addition to detergent compositions, the compounds of the present invention may be also suitable for use or incorporation into industrial cleaners (i.e. floor cleaners). Often these detergent compositions will additionally comprise surfactants and other detergent adjunct ingredients, discussed in more detail below. In one embodiment, the detergent composition of the present invention is a liquid or solid laundry detergent composition. In another embodiment, the detergent composition of the present invention is a hard surface detergent composition, preferably wherein the hard surface detergent composition impregnates a nonwoven substrate. As used herein “impregnate” means that the hard surface detergent composition in place in contact with a nonwoven substrate such that the hard surface detergent composition penetrates into at least a portion of the nonwoven substrate, preferably saturating the nonwoven substrate.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Copolymers

The present invention relates to a detergent composition comprising from about 0.01% to about 20%, preferably from about 0.01% to about 10%, more preferably from about 0.01% to about 8%, by weight of the detergent composition, of a copolymer, in copolymerized form. The copolymer comprises monomers selected from the group comprising monomers (I) and (II). Monomer (I) comprises from about 60 to about 99% by weight of the copolymer of at least one monoethylenically unsaturated polyalkylene oxide monomer of the formula (I) 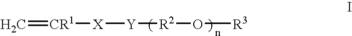
wherein Y of formula (I) is selected from —O— and —NH—; if Y of formula (I) is —O—, X of formula (I) is selected from —CH₂— or —CO—, if Y of formula (I) is —NH—, X of formula (I) is —CO—; R¹ of formula (I) is selected from hydrogen, methyl, and mixtures thereof; R² of formula (I) is independently selected from linear or branched C₂-C₆-alkylene radicals, which may be arranged blockwise or randomly; R³ of formula (I) is selected from hydrogen, C₁-C₄-alkyl, and mixtures thereof; n of formula (I) is an integer from 3 to 50.

Monomer (II) comprises from about 1 to about 40% by weight of the copolymer of at least one quaternized nitrogen-containing monoethylenically unsaturated monomer. The monomers are selected such that the copolymer has a weight average molecular weight (M_{w}) of from 2,000 to 100,000.

The copolymer for use in the present invention may further comprise monomers (III) and (IV). Monomer (III) may comprise from 0% to about 39% by weight of the copolymer of an anionic monoethylenically unsaturated monomer. Monomer (IV) may comprise from 0% to about 30% by weight of the copolymer of other nonionic monoethylenically unsaturated monomers.

Preferred copolymers according to the invention comprise, as copolymerized monomer (I), monoethylenically unsaturated polyalkylene oxide monomers of formula (I) in which Y of formula (I) is —O—; X of formula (I) is —CO— or —CH₂—; R¹ of formula (I) is hydrogen or methyl; R² of formula (I) is independently selected from linear or branched C₂-C₄-alkylene radicals arranged blockwise or randomly, preferably ethylene, 1,2- or 1,3-propylene or mixtures thereof, particularly preferably ethylene; R³ of formula (I) is methyl; and n is an integer from 5 to 30.

Monomer (I)

A monomer (I) for use in the copolymer of the present invention may be, for example:
(A) reaction products of (meth)acrylic acid with polyalkylene glycols which are not terminally capped, terminally capped at one end by alkyl radicals, aminated at one end or terminally capped at one end by alkyl radicals and aminated at one end; and
(B) alkyl ethers of polyalkylene glycols which are not terminally capped or terminally capped at one end by alkyl, phenyl or alkylphenyl radicals.

Preferred monomer (I) is the (meth)acrylates and the allyl ethers, where the acrylates and primarily the methacrylates are particularly preferred. Particularly suitable examples of the monomer (I) that may be mentioned are:
(A) methylpolyethylene glycol (meth)acrylate and (meth)acrylamide, methylpolypropylene glycol (meth)acrylate and (meth)acrylamide, methylpolybutylene glycol (meth)acrylate and (meth)acrylamide, methylpoly(propylene oxide-co-ethylene oxide) (meth)acrylate and (meth)acrylamide, ethylpolyethylene glycol (meth)acrylate and (meth)acrylamide, ethylpolypropylene glycol (meth)acrylate and (meth)acrylamide, ethylpolybutylene glycol (meth)acrylate and (meth)acrylamide and ethylpoly(propylene oxide-co-ethylene oxide) (meth)acrylate and (meth)acrylamide, each with 3 to 50, preferably 3 to 30 and particularly preferably 5 to 30, alkylene oxide units, where methylpolyethylene glycol acrylate is preferred and methylpolyethylene glycol methacrylate is particularly preferred;
(B) ethylene glycol allyl ethers and methylethylene glycol allyl ethers, propylene glycol allyl ethers and methylpropylene glycol allyl ethers each with 3 to 50, preferably 3 to 30 and particularly preferably 5 to 30, alkylene oxide units.

The proportion of monomer (I) in the copolymer according to the invention is 60% to 99% by weight, preferably 65% to 90% by weight of the copolymer.

Monomer (II)

A monomer (II) that is particularly suitable for the copolymer according to the invention include the quaternization products of 1-vinylimidazoles, of vinylpyridines, of (meth)acrylic esters with amino alcohols, in particular N,N-di-C₁-C₄-alkylamino-C₂-C₆-alcohols, of amino-containing (meth)acrylamides, in particular N,N-di-C₁-C₄-alkyl-amino-C₂-C₆-alkylamides of (meth)acrylic acid, and of diallylalkylamines, in particular diallyl-C₁-C₄-alkylamines.

Suitable monomers (II) have the formula IIa to IId: 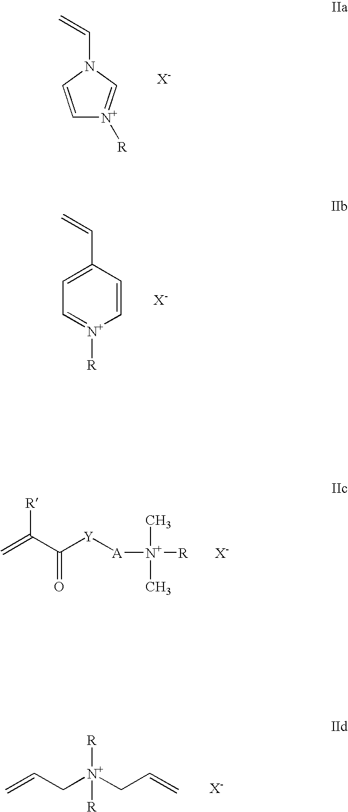
wherein R of formula IIa to IId is selected from C₁-C₄-alkyl or benzyl, preferably methyl, ethyl or benzyl; R¹ of formula IIc is selected from hydrogen or methyl; Y of formula IIc is selected from —O— or —NH—; A of formula IIc is selected from C₁-C₆-alkylene, preferably straight-chain or branched C₂-C₄-alkylene, in particular 1,2-ethylene, 1,3- and 1,2-propylene or 1,4-butylene; X— of formula IIa to IId is selected from halide, such as iodide and preferably chloride or bromide, C₁-C₄-alkyl sulfate, preferably methyl sulfate or ethyl sulfate, C₁-C₄-alkylsulfonate, preferably methylsulfonate or ethylsulfonate, C₁-C₄-alkyl carbonate; and mixtures thereof.

Specific examples of preferred monomer (II) that may be utilized in the present invention are:
(A) 3-methyl-i-vinylimidazolium chloride, 3-methyl-i-vinylimidazolium methyl sulfate, 3-ethyl-i-vinylimidazolium ethyl sulfate, 3-ethyl-i-vinylimidazolium chloride and 3-benzyl-1-vinylimidazolium chloride;
(B) 1-methyl4-vinylpyridinium chloride, 1-methyl-4-vinylpyridinium methyl sulfate and 1-benzyl4-vinylpyridinium chloride;
(C) methacrylamidopropyltrimethylammonium chloride, methacrylamidoethyltrimethylammonium chloride, trimethylammonium ethyl acrylate chloride and methyl sulfate, trimethylammonium ethyl methacrylate chloride and methyl sulfate, dimethylethylammonium ethyl acrylate ethyl sulfate, dimethylethylammonium ethylmethacrylate ethyl sulfate, trimethylammonium propyl acrylate chloride and methyl sulfate and trimethylammonium propyl methacrylate chloride and methyl sulfate; and
(D) dimethyldiallylammonium chloride and diethyldiallylammonium chloride. A preferred monomer (II) is selected from 3-methyl-1-vinylimidazolium chloride, 3-methyl-i-vinylimidazolium methyl sulfate, methacrylamidopropyltrimethylammonium chloride, trimethylammonium ethyl methacrylate chloride, dimethylethylammonium ethylmethacrylate ethyl sulfate and dimethyldiallylammonium chloride.

The copolymer according to the invention comprises 1% to 40% by weight, preferably 3% to 30% by weight of the copolymer, of monomer (II). The weight ratio of monomer (II) to monomer (I) is preferably equal to or greater than 1:1, preferably 1:1 to 1:4.

Monomer (III)

As optional components of the copolymer of the present invention, monomers (III) and (IV) may also be utilized. Monomer (III) is selected from anionic monoethylenically unsaturated monomers. Suitable monomer (III) may be selected from:
(A) α,β-unsaturated monocarboxylic acids which preferably have 3 to 6 carbon atoms, such as acrylic acid, methacrylic acid, ethacrylic acid, crotonic acid and vinylacetic acid, preference being given to acrylic acid and methacrylic acid;
(B) unsaturated dicarboxylic acids, which preferably have 4 to 6 carbon atoms, such as itaconic acid and maleic acid, anhydrides thereof, such as maleic anhydride;
(C) ethylenically unsaturated sulfonic acids, such as vinylsulfonic acid, acrylamido-propanesulfonic acid, methallylsulfonic acid, methacrylsulfonic acid, m- and p-styrenesulfonic acid, (meth)acrylamidomethanesulfonic acid, (meth)acrylamido-ethanesulfonic acid, (meth)acrylamidopropanesulfonic acid, 2-(meth)acrylamido-2-methylpropanesulfonic acid, 2-acrylamido-2-butanesulfonic acid, 3-methacrylamido-2-hydroxypropanesulfonic acid, methanesulfonic acid acrylate, ethanesulfonic acid acrylate, propanesulfonic acid acrylate, allyloxybenzenesulfonic acid, methallyloxybenzenesulfonic acid and 1-allyloxy-2-hydroxypropanesulfonic acid;
(D) ethylenically unsaturated phosphonic acids, such as vinylphosphonic acid and m- and p-styrenephosphonic acid; and
(E) acidic phosphate esters of C₂-C₄-alkylene glycol mono(meth)acrylates and poly(C₂-C₄-alkylene) glycol mono(meth)acrylates, such as ethylene glycol mono(meth)acrylate, propylene glycol mono(meth)acrylate, polyethylene glycol mono(meth)acrylates and polypropylene glycol mono(meth)acrylates.

The anionic monomer (III) can be present in the form of water soluble free acids or in water-soluble salt form, especially in the form of alkali metal and ammonium, in particular alkylammonium, salts, and preferred salts being the sodium salts.

A preferred monomer (III) may be selected from acrylic acid, methacrylic acid, maleic acid, vinylsulfonic acid, 2-(meth)acrylamido-2-methylpropanesulfonic acid and vinylphosphonic acid, particular preference being given to acrylic acid, methacrylic acid and 2-acrylamido-2-methylpropanesulfonic acid.

The proportion of monomer (III) in the copolymer of the invention can be up to 39% by weight, preferably from 3% to 30% by weight of the copolymer. If monomer (III) is present in the copolymer of the present invention, then the weight ratio of monomer (I) to monomer (III) is preferably equal to or greater than 1:1.

Monomer (IV)

As an optional component of the copolymer of the present invention, monomer (IV) may also be utilized. Monomer (IV) is selected from nonionic monoethylenically unsaturated monomers selected from:
(A) esters of monoethylenically unsaturated C₃-C₆-carboxylic acids, especially acrylic acid and methacrylic acid, with monohydric C₁-C₂₂-alcohols, in particular C₁-C₁₆-alcohols; and hydroxyalkyl esters of monoethylenically unsaturated C₃-C₆-carboyxlic acids, especially acrylic acid and methacrylic acid, with divalent C₂-C₄-alcohols, such as methyl (meth)acrylate, ethyl (meth)acrylate, n-butyl (meth)acrylate, sec-butyl (meth)acrylate, tert-butyl (meth)acrylate, ethylhexyl (meth)acrylate, decyl (meth)acrylate, lauryl (meth)acrylate, isobornyl (meth)acrylate, cetyl (meth)acrylate, palmityl (meth)acrylate and stearyl (meth)acrylate, hydroxyethyl (meth)acrylate, hydroxypropyl (meth)acrylate and hydroxybutyl (meth)acrylate;
(B) amides of monoethylenically unsaturated C₃-C₆-carboxylic acids, especially acrylic acid and methacrylic acid, with C₁-C₁₂-alkylamines and di(C₁-C₄-alkyl)amines, such as N-methyl(meth)acrylamide, N,N-dimethyl(meth)acrylamide, N-ethyl(meth)acrylamide, N-propyl(meth)acrylamide, N-tert-butyl(meth)acrylamide, N-tert-octyl(meth)acrylamide and N-undecyl(meth)acrylamide, and (meth)acrylamide;
(C) vinyl esters of saturated C₂-C₃₀-carboxylic acids, in particular C₂-C₁₄-carboxylic acids, such as vinyl acetate, vinyl propionate, vinyl butyrate, vinyl 2-ethylhexanoate and vinyl laurate;
(D) vinyl C₁-C₃₀-alkyl ethers, in particular vinyl C₁-C₁₈-alkyl ethers, such as vinyl methyl ether, vinyl ethyl ether, vinyl n-propyl ether, vinyl isopropyl ether, vinyl n-butyl ether, vinyl isobutyl ether, vinyl 2-ethylhexyl ether and vinyl octadecyl ether;
(E) N-vinylamides and N-vinyllactams, such as N-vinylformamide, N-vinyl-N-methyl-formamide, N-vinylacetamide, N-vinyl-N-methylacetamide, N-vinylpyrrolidone, N-vinylpiperidone and N-vinylcaprolactam;
(F) aliphatic and aromatic olefins, such as ethylene, propylene, C₄-C₂₄-α-olefins, in particular C₄-C₁₆-α-olefins, e.g. butylene, isobutylene, diisobutene, styrene and α-methylstyrene, and also diolefins with an active double bond, e.g. butadiene;
(G) unsaturated nitriles, such as acrylonitrile and methacrylonitrile.

A preferred monomer (IV) is selected from methyl (meth)acrylate, ethyl (meth)acrylate, (meth)acrylamide, vinyl acetate, vinyl propionate, vinyl methyl ether, N-vinylformamide, N-vinylpyrrolidone and N-vinylcaprolactam.

If the monomer (IV) is present in the copolymer of the present invention, then the proportion of monomer (IV) may be up to 30% by weight of the copolymer.

Preferred copolymers of the present invention include, but are not limited to formulae (III)-(XI). 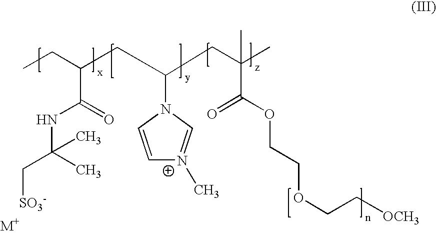
wherein M+ is hydrogen or a water soluble cation such as alkali metals, or ammonium; indices x, y, and z of formula (III) are such that the monomer ratio (x:y:z) is from 1:0.5:1 to 5 1:2:2 and has a weight average molecular weight between 5000 and 15000. 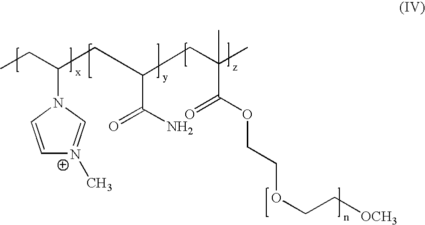
wherein indices x, y, and z of formula (IV) are such that the monomer ratio (x:y:z) is from 1:0.5:1 to 1:1:1 and has a weight average molecular weight between 4000 and 10000. 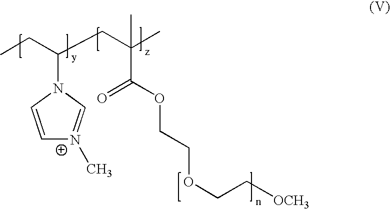
wherein indices y and z of formula (V) are such that the monomer ratio (y:z) is from 1:1 to 1:4 and has a weight average molecular weight between 5000 and 15000. 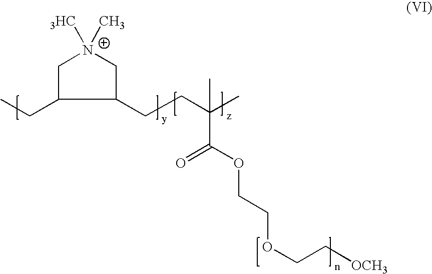
wherein indices y and z of formula (VI) are such that the monomer ratio (y:z) is from 1:1 to 1:4 and has a weight average molecular weight between 5000 and 15000. 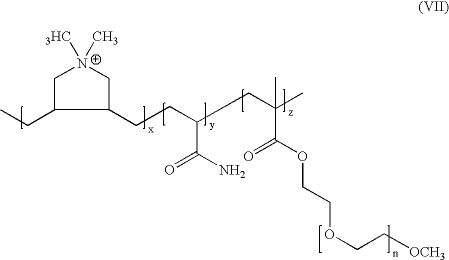
wherein indices x, y, and z of formula (VII) are such that the monomer ratio (x:y:z) is from 1:0.5:1 to 1:1: 1 and has a weight average molecular weight between 5000 and 15000. 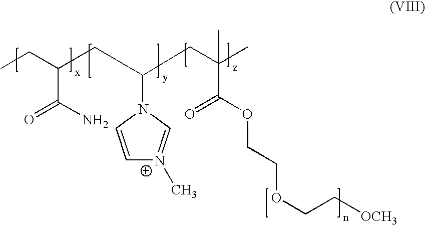
wherein indices x, y, and z of formula (VIII) are such that the monomer ratio (x:y:z) is from 1:1:1 to 10:1:2, including but not limited to 6:1:1, 6:1:2, 10:1:1, and 10:1:2 and has a weight average molecular weight between 10000 and 75000, preferably 10000 or 50000. 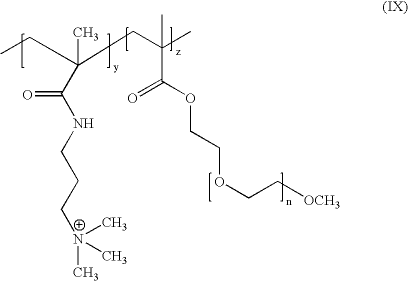
wherein indices y and z of formula (IX) are such that the monomer ratio (y:z) is from 1:1 to 1:2 and has a weight average molecular weight between 4000 and 15000. 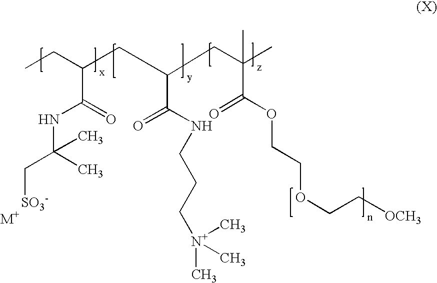
wherein M+ is hydrogen or a water soluble cation such as alkali metals, or ammonium; indices x, y, and z of formula (X) are such that the monomer ratio (x:y:z) is from 1:0.5:1 to 1:2:2 and has a weight average molecular weight between 5000 and 15000. 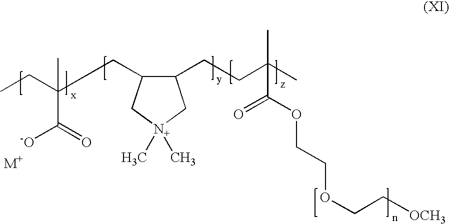
wherein M+ is hydrogen or a water soluble cation such as alkali metals, or ammonium; indices x, y, and z of formula (XI) are such that the monomer ratio (x:y:z) is from 1:0.5:1 to 1:2:2 and has a weight average molecular weight between 5000 and 15000.

The copolymers according to the invention have a weight average molecular weight (M_{w}) of from 2000 to 100000, preferably from 3000 to 50000 and particularly preferably from 3000 to 25000.

The copolymers according to the invention can be prepared by free-radical polymerization of the monomers (I) and (II) and if desired (III) and/or (IV). The free-radical polymerization of the monomers can be carried out in accordance with all known methods, preference being given to the processes of solution polymerization and of emulsion polymerization.

Suitable polymerization initiators are compounds which decompose thermally or photochemically (photoinitiators) to form free radicals, such as benzophenone, acetophenone, benzoin ether, benzyl dialkyl ketones and derivatives thereof.

The polymerization initiators are used according to the requirements of the material to be polymerized, usually in amounts of from 0.01% to 15%, preferably 0.5% to 5% by weight based on the monomers to be polymerized, and can be used individually or in combination with one another.

Instead of a quaternized monomer (II), it is also possible to use the corresponding tertiary amines. In this case, the quaternization is carried out after the polymerization by reacting the resulting copolymer with alkylating agents, such as alkyl halides, dialkyl sulfates and dialkyl carbonates, or benzyl halides, such as benzyl chloride. Examples of suitable alkylating agents which may be mentioned are, methyl chloride, bromide and iodide, ethyl chloride and bromide, dimethyl sulfate, diethyl sulfate, dimethyl carbonate and diethyl carbonate.

The anionic monomer (III) can be used in the polymerization either in the form of the free acids or in a form partially or completely neutralized with bases. Specific examples that may be listed are: sodium hydroxide solution, potassium hydroxide solution, sodium carbonate, sodium hydrogen carbonate, ethanolamine, diethanolamine and triethanolamine.

To limit the molar masses of the copolymers according to the invention, customary regulators can be added during the polymerization, e.g. mercapto compounds, such as mercaptoethanol, thioglycolic acid and sodium disulfite. Suitable amounts of regulator are 0.1% to 5% by weight based on the monomers to be polymerized.

Surfactants—Surfactant that may be used for the present invention may comprise a surfactant or surfactant system comprising surfactants selected from nonionic, anionic, cationic surfactants, ampholytic, zwitterionic, semi-polar nonionic surfactants, other adjuncts such as alkyl alcohols, or mixtures thereof.

The detergent composition of the present invention further comprises from about from about 0.01% to about 90%, preferably from about 0.01% to about 80%, more preferably from about 0.05% to about 60%, most preferably from about 0.05% to about 30% by weight of the detergent composition of a surfactant system having one or more surfactants.

Anionic Surfactants

Nonlimiting examples of anionic surfactants useful herein include C₁₁-C₁₈ alkyl benzene sulfonates (LAS); C₁₀-C₂₀ primary, branched-chain and random alkyl sulfates (AS); C₁₀-C₁₈ secondary (2,3) alkyl sulfates; C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, WO 99/05244; methyl ester sulfonate (MES); and alpha-olefin sulfonate (AOS).

Nonionic Surfactants Non-limiting examples of nonionic surfactants include C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as PLURONIC@ from BASF; C₁₄-C₂₂ mid-chain branched alcohols as discussed in U.S. Pat. No. 6,150,322; C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 Llenado, issued Jan. 26, 1986; specifically alkylpolyglycosides as discussed in U.S. 4,483,780 and U.S. Pat. No. 4,483,779; Polyhydroxy fatty acid amides (GS-base) as discussed in U.S. Pat. No. 5,332,528, WO 92/06162, WO 93/19146, WO 93/19038, and WO 94/09099; ether capped poly(oxyalkylated) alcohol surfactants as discussed in U.S. Pat. No. 6,482,994 and WO 01/42408.

Cationic Surfactants

Non-limiting examples of anionic surfactants include: the quaternary ammonium surfactants, which can have up to 26 carbon atoms, such as alkoxylate quaternary ammonium (AQA) surfactants as discussed in U.S. Pat. No. 6,136,769; dimethyl hydroxyethyl quaternary ammonium (K1) as discussed in U.S. Pat. No. 6,004,922.

Detergent Adjunct Materials and Methods of Use

In general, a detergent adjunct is any material required to transform a detergent composition containing only the minimum essential ingredients into a detergent composition useful for laundry, consumer, commercial and/or industrial cleaning purposes. In certain embodiments, detergent adjuncts are easily recognizable to those of skill in the art as being absolutely characteristic of detergent products, especially of detergent products intended for direct use by a consumer in a domestic environment.

The precise nature of these additional components, and levels of incorporation thereof, will depend on the physical form of the detergent composition and the nature of the cleaning operation for which it is to be used.

The detergent adjunct ingredients if used with bleach should have good stability therewith. Certain embodiments of detergent compositions herein should be boron-free and/or phosphate-free as required by legislation. Levels of detergent adjuncts are from about 0.00001% to about 99.9%, by weight of the detergent compositions. Use levels of the overall detergent compositions can vary widely depending on the intended application, ranging for example from a few ppm in solution to so-called “direct application” of the neat detergent composition to the surface to be cleaned.

Quite typically, detergent compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials and methods can be found in WO 99/05242.

Adjunct Materials

Common adjuncts include builders, surfactants, enzymes, polymers, bleaches, bleach activators, catalytic materials and the like excluding any materials already defined hereinabove as part of the essential component of the inventive compositions. Other adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents. Suitable examples of such other adjuncts and levels of use are found in U.S. Pat. Nos. 5,576,282, 6,306,812 B1 and 6,326,348 B1.

Method of Use

The present invention includes a method for cleaning a situs inter alia a surface or fabric. Such method includes the steps of contacting an embodiment of Applicants' detergent composition, in neat form or diluted in wash liquor, with at least a portion of a surface or fabric then rinsing such surface or fabric. Preferably the surface or fabric is subjected to a washing step prior to the aforementioned rinsing step. For purposes of the present invention, washing includes but is not limited to, scrubbing, and mechanical agitation.

As will be appreciated by one skilled in the art, the detergent compositions of the present invention are ideally suited for use in laundry applications. Accordingly, the present invention includes a method for laundering a fabric. The method comprises the steps of contacting a fabric to be laundered with a laundry solution comprising at least one embodiment of a detergent composition, cleaning additive or mixture thereof comprising the present invention. The fabric may comprise most any fabric capable of being laundered in normal consumer use conditions. The solution preferably has a pH of from about 8 to about 10. The compositions are preferably employed at concentrations of from about 500 ppm to about 10,000 ppm in solution. The water temperatures preferably range from about 5 ° C. to about 60 ° C. The water to fabric ratio is preferably from about 1: 1 to about 20: 1.

The present invention included a method for cleaning a situs inter alia a surface or fabric. Such method includes the step of contacting a nonwoven substrate impregnated with an embodiment of the detergent composition of the present invention, contacting the nonwoven substrate with at least a portion of a hard surface or fabric. The method may further comprise a rinsing step. For purposes of the present invention, washing includes but is not limited to, scrubbing, and mechanical agitation. As used herein “nonwoven substrate” can comprise any conventionally fashioned nonwoven sheet or web having suitable basis weight, caliper (thickness), absorbency and strength characteristics. Examples of suitable commercially available nonwoven substrates include those marketed under the tradename SONTARA® by DuPont and POLYWEB® by James River Corp.

As will be appreciated by one skilled in the art, the detergent compositions of the present invention are ideally suited for use in hard surface applications. Accordingly, the present invention includes a method for cleaning hard surfaces. The method comprises the steps of contacting a hard surface to be cleaned with a hard surface solution or nonwoven substrate impregnated with an embodiment of the detergent composition. The method of use of the nonwoven substrate when contacting a hard surface may be by the hand of a user or by the use of an implement to which the nonwoven substrate attaches.

Examples—Preparation Of Copolymers According To The Present Invention

The weight average molecular weights (M_{w}) given below were determined according to the method of size exclusion chromatography using narrow-distribution linear polymaltotriose, and maltohexose as calibration standard.

Copolymer 1

Add 246.5 g of water into a 21 polymerization vessel fitted with stirrer, reflux condenser, internal thermometer and dropping funnel and, flush with nitrogen, heat to 80° C. Add 568.8 g of a 50% strength by weight aqueous solution of methyl polyethylene glycol methacrylate (Mₙ 1000) (feed 1), 34.7 g of a 45% strength by weight aqueous solution of 3-methyl-1-vinylimidazolium methyl sulfate (feed 2), a mixture of 15 g of mercaptoethanol and 50 g of water (feed 3) and an initiator mixture of 6.0 g of 2,2′-azobis(2-amidinopropane) dihydrochloride and 80 g of water (feed 4) continuously drop-wise (feed 1, 2 and 3 in 3 hours, feed 4 in 4 hours). When the initiator addition is complete, stir the reaction mixture for a 1 h at 80° C., then add another initiator mixture comprising 1.5 g of 2,2′-azobis(2-amidinopropane) dihydrochloride and 20 g of water in one portion at 80° C. Stir for a two hours at 80° C., then add 2.75 g of 30% strength by weight hydrogen peroxide and stir the mixture for a 30 min at 80° C. After cooling to room temperature (20° C.-25° C.), filter the reaction mixture.

A slightly yellowish, clear polymer solution with a solids content of 30.4% by weight and a pH of 4.6 should be recovered. The average molecular weight M_{w} of the copolymer should be 4600.

Copolymer 2

Introduce 239.0 g of water into a 2 1 polymerization vessel fitted with stirrer, reflux condenser, internal thermometer and dropping funnel and flush with nitrogen, heat to 80° C. Add 51.5 g of a 50% strength by weight aqueous solution of 2-acrylamido-2-methylpropanesulfonic acid sodium salt (feed 1), 109.9 g of a 45% strength by weight aqueous solution of 3-methyl-1-vinylimidazolium methyl sulfate (feed 2), 449.6 g of a 50% strength by weight aqueous solution of methyl polyethylene glycol methacrylate (Mₙ 1000) (feed 3), a mixture of 9 g of mercaptoethanol and 50 g of water (feed 4) and an initiator mixture of 6.0 g of 2,2′-azobis(2-amidinopropane) dihydrochloride and 80 g of water (feed 5) continuously dropwise (feed 1, 2, 3 and 4 in 3 hours, feed 5 in 4 hours). When the initiator addition is complete, stir the reaction mixture for 1 hour at 80° C., then add another initiator mixture comprising 1.5 g of 2,2′-azobis(2-amidinopropane) dihydrochloride and 20 g of water in one portion at 80° C. Stir for a two hours at 80° C, add 1.65 g of 30% strength hydrogen peroxide and stir the mixture for 30 min at 80° C. After cooling to room temperature (20° C.-25° C.), filter, and add 3.6 of a 10% strength by weight sodium hydroxide solution to the filtrate.

This should produce a slightly yellowish, clear polymer solution with a solids content of 30.7% by weight and a pH of 6.5. The average molecular weight M_{w} of the copolymer should be 6100.

Copolymer 3

Introduce 243.7 g of water into a 2 1 polymerization vessel fitted with stirrer, reflux condenser, internal thermometer and dropping funnel and flush with nitrogen, and heat to 80° C. Add a mixture of 20.7 g of methacrylic acid and 40 g of water (feed 1), 64.7 g of a 60% strength by weight aqueous solution of diallyldimethylammonium chloride (feed 2), 480.9 g of a 50% strength by weight aqueous solution of methyl polyethylene glycol methacrylate (Mₙ 1000) (feed 3), a mixture of 9 g of mercaptoethanol and 50 g of water (feed 4) and an initiator mixture of 6.0 g of 2,2′-azobis(2-amidinopropane) dihydrochloride and 80 g of water (feed 5) continuously dropwise (feed 1, 2, 3 and 4 in 3 hours, feed 5 in 4 hours). When the initiator addition is complete, stir the reaction mixture for 1 h at 80° C., add in one portion another initiator mixture comprising 1.5 g of 2,2′-azobis(2-amidinopropane) dihydrochloride and 20 g of water at 80° C. Stir for two hours at 80° C., add 1.65 g of 30% strength by weight hydrogen peroxide and stir the mixture for 30 min at 80° C. After cooling to room temperature (20° C.-25° C.), filter, and add 75 g of 10% strength by weight sodium hydroxide solution to the filtrate.

This should yield a slightly yellowish, clear polymer solution with a solids content of 28.8% by weight and a pH of 6.5. The average molecular weight M_{w} of the copolymer should be 9800.

Copolymer 4

Introduce 197.0 g of water into a 2 1 polymerization vessel fitted with stirrer, reflux condenser, internal thermometer and dropping funnel and, flush with nitrogen, and heat to 80° C. Add 417.9 g of a 50% strength by weight aqueous solution of methylpolyethylene glycol methacrylate (Mₙ 1000) (feed 1), 92.1 g of a 50% strength by weight aqueous solution of methacrylamidopropyltrimethylammonium chloride (feed 2), a mixture of 13 g of mercaptoethanol and 50 g of water (feed 3) and an initiator mixture of 5.1 g of 2,2′-azobis(2-amidinopropane) dihydrochloride and 80 g of water (feed 4) continuously dropwise (feed 1, 2 and 3 in 3 hours, feed 4 in 4 hours). When the initiator addition is complete, stir the reaction mixture for 1 hour at 80° C., then add in one portion another initiator mixture comprising 1.3 g of 2,2′-azobis(2-amidinopropane) dihydrochloride and 20 g of water at 80° C. Stir for two hours at 80° C., add 1.95 g of 30% strength by weight hydrogen peroxide and stir the mixture for a further 30 min at 80° C. After cooling to room temperature (20° C.-25° C.), filter the reaction mixture.

This should yield a slightly yellowish, clear polymer solution with a solids content of 32.7% by weight and a pH of 5.6. The average molecular weight M_{w} of the copolymer should be 5000.

Copolymer 5

Introduce 250.1 g of water into a 2 1 polymerization vessel fitted with stirrer, reflux condenser, internal thermometer and dropping funnel, flush with nitrogen, and heat to 80° C. Add 51.5 g of a 50% strength by weight aqueous solution of 2-acrylamido-2-methylpropanesulfonic acid sodium salt (feed 1), 54.0 g of a 50% strength by weight aqueous solution of methacrylamidopropyltrimethylammonium chloride (feed 2), 489.8 g of a 50% strength by weight aqueous solution of methylpolyethylene glycol methacrylate (Mₙ 1000) (feed 3), a mixture of 9 g of mercaptoethanol and 50 g of water (feed 4) and an initiator mixture of 6.0 g of 2,2′-azobis(2-amidinopropane) dihydrochloride and 80 g of water (feed 5) continuously dropwise (feed 1, 2, 3 and 4 in 3 hours, feed 5 in 4 hours). When the initiator addition is complete, stir the mixture for 1 h at 80° C., then add in one portion another initiator mixture comprising 1.5 g of 2,2′-azobis(2-amidinopropane) dihydrochloride and 20 g of water at 80° C. Stir for two hours at 80° C., add 1.65 g of 30% strength by weight hydrogen peroxide and stir the mixture for 30 min at 80° C. After cooling to room temperature (20° C.-25° C.), filter, and add 0.8 g of 10% strength by weight sodium hydroxide solution to the filtrate.

This should yield a slightly yellowish, clear polymer solution with a solids content of 30.2% by weight and a pH of 6.5. The average molecular weight M_{w} of the copolymer should be 6500.

Use of Copolymers According to the Invention in Laundry Detergents

For the washing experiments, a solid laundry detergent formulation based on zeolite (LD 1), a solid laundry detergent formulation based on phosphate (LD 3), a liquid laundry detergent formulation (LD 2), and liquid laundry detergent formulation (LD 4) and a liquid laundry detergent formulation (LD 5) are used. The formulations are given in Table 1. The washing conditions are listed in Table 3.

TABLE 1

| | LD 1 | LD 2 | LD 3 | LD4 | LD5 |
|---|---|---|---|---|---|
| Ingredients | [% by wt.] | [% by wt.] | [% by wt.] | [% by wt.] | [% by wt.] |
| Linear alkylbenzenesulfonate | 5.0 | — | 20.0 | 10-15 | 10-15 |
| C₁₂₋₁₅ alcohol ethoxy_{(1.1-2.5)} | — | — | — | 1-5 | 1-5 |
| sulfate | | | | | |
| C₁₂-C₁₈-Alkyl sulfate | — | 26.7 | — | — | — |
| C₁₂-Fatty alcohol ethoxy (2) | — | 7.1 | — | — | — |
| sulfate | | | | | |
| C₁₃C₁₅-Oxo ethoxy (7) alcohol | 5.0 | — | — | — | — |
| C₁₂C₁₄-Fatty ethoxy (7) alcohol | — | 6.0 | — | — | — |
| C₁₂₋₁₃ alcohol ethoxylate₍₇₋₉₎ | — | — | — | 1-5 | 1-5 |
| cocodimethyl amine oxide | — | — | — | 0.1-1 | 0.1-1 |
| Soap | 1.4 | — | — | — | — |
| Coconut fatty acid | — | 5.0 | — | — | — |
| fatty acid | — | — | — | 1-5 | 1-5 |
| Potassium hydroxide | — | 1.4 | — | — | — |
| citric acid | — | — | — | 1-5 | 1-5 |
| Sodium citrate × 2 H₂O | — | 2.1 | — | — | — |
| Zeolite A | 30.0 | — | — | — | — |
| Pentasodium triphosphate | — | — | 20.0 | — | — |
| Sodium carbonate | 12.0 | — | 10.0 | — | — |
| Sodium metasilicate × 5 H₂O | 3.6 | — | 4.5 | — | — |
| Disodium tetraborate | — | 2.2 | — | — | — |
| Sodium perborate monohydrate | 20.0 | — | — | — | — |
| Tetraacetylethylenediamine | 6.0 | — | — | — | — |
| Polymer a¹ | — | — | — | 0.1-1.5 | — |
| Polymer b² | — | — | — | 0.1-1.5 | — |
| Polymer c³ | — | — | — | — | 0.5-3 |
| Methylpropylglycol | — | 10 | — | — | — |
| hydroxylated castor oil | — | — | — | 5-20 | 5-20 |
| (structurant) | | | | | |
| Sodium sulfate | 7.0 | — | 25.0 | — | — |
| Water, perfumes, dyes, and | ad 100 | ad 100 | ad 100 | ad 100 | ad 100 |
| other adjunct ingredients | | | | | |

¹one or more polymers according to U.S. Pat. No. 4,891,160, VanderMeer, et al.
²one or more polymers according to WO 00/105923, Price, et al.
³polymer according to any one of Formulae III-XI of the present application.

TABLE 2
Hard Surface Cleaning Compositions

| | floor cleaning | floor cleaning |
|---|---|---|
| | wipe solution | solution |
| C₁₁ alcohol ethoxylate | 0.03% | 0.03% |
| (EO = 5) | | |
| Sodium C₈ Sulfonate | 0.01% | 0.01% |
| Propylene Glycol n-Butyl | 2.00% | 2.00% |
| Ether | | |
| 2-Phenoxyethanol | 0.05% | 0.05% |
| Ethanol | — | 3.0% |
| Polymer¹ | 0.015% | 0.015% |
| 2-Dimethylamino-2-methyl- | 0.01% | 0.01% |
| 2-propanol (DMAMP) | | |
| perfume | 0.01-0.06% | 0.01-0.06% |
| Suds suppressor² | 0.003% | 0.003% |
| 2-methyl-4-isothaizolin-3one + chloro | 0.015% | — |
| derivative | | |
| Water and other adjunct | ad 100 | ad 100 |
| ingredients | | |

¹polymer according to any one of Formulae III-XI of the present application.
²such as Dow Corning AF Emulsion or polydimethyl siloxane

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent composition comprising:
(A) from about 0.01% to about 20% by weight of the detergent composition of a copolymer which comprises, in copolymerized form:
(I) 60% to 99% by weight of the copolymer at least one monoethylenically unsaturated polyalkylene oxide monomer of the formula I: 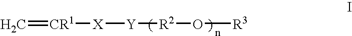
wherein Y of formula (I) is selected from —O— and —NH—; if Y of formula (I) is —O—, X of formula (I) is selected from —CH₂— or —CO—, or if Y of formula (I) is —NH—X of formula (I) is —CO—; R¹ of formula (I) is selected from hydrogen, methyl, and mixtures thereof; R² of formula (I) is independently selected from linear or branched C₂-C₆-alkylene radicals; R³ of formula (I) is selected from hydrogen, C₁-C₄-alkyl, and mixtures thereof; n of formula (I) is an integer from 3 to 50;
(II) 1% to 40% by weight of the copolymer at least one quaternized nitrogen-containing monoethylenically unsaturated monomer,
(III) 0% to 39% by weight of the copolymer of anionic monoethylenically unsaturated monomers; and
(IV) 0% to 30% by weight of the copolymer of other nonionic monoethylenically unsaturated monomers
wherein the copolymer has an average molecular weight M_{w} of from 2,000 to 100,000.
(B) from about 0.01% to about 90% by weight of the detergent composition of a surfactant system having one or more surfactants selected from anionic surfactants, nonionic surfactants, cationic surfactants, zwitterionic surfactants, amphoteric surfactants, and mixtures thereof.

2. The detergent composition of claim 1 wherein the copolymer comprises formula (I) wherein Y of formula (I) is —O—; X of formula (I) is —CO— or —CH₂—; R¹ of formula (I) is hydrogen or methyl; R² of formula (I) is independently selected from ethylene, propylene or mixtures thereof; R³ of formula (I) is methyl; n of formula (I) is an integer from 5 to 30.

3. The detergent composition of claim 1 wherein the copolymer monomer (II) selected from the group consisting of formula IIa to IId: 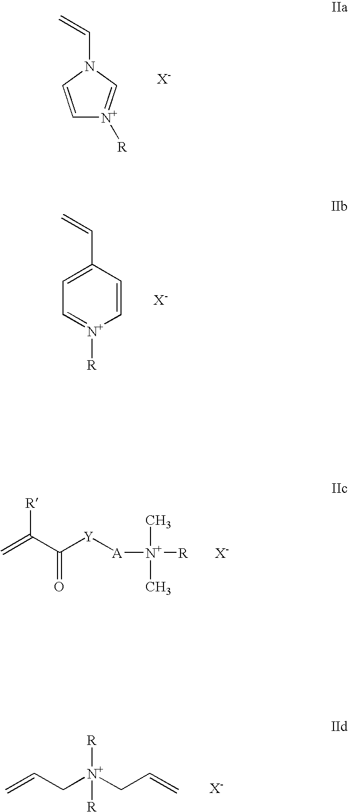
wherein R of formula IIa to IId is selected from C₁-C₄-alkyl or benzyl, preferably methyl, ethyl or benzyl; R¹ of formula IIc is selected from hydrogen or methyl; Y of formula IIc is selected from —O— or —NH—; A of formula IIc is selected from C₁-C₆-alkylene, preferably straight-chain or branched C₂-C₄-alkylene, in particular 1,2-ethylene, 1,3- and 1,2-propylene or 1,4-butylene; X— of formula IIa to IId is selected from halide, such as iodide and preferably chloride or bromide, C₁-C₄-alkyl sulfate, preferably methyl sulfate or ethyl sulfate, C₁-C₄-alkylsulfonate, preferably methylsulfonate or ethylsulfonate, C₁-C₄-alkyl carbonate; and mixtures thereof.

4. The detergent composition of claim 1 wherein the copolymer comprises monomer (IV).

5. The detergent composition of claim 1 wherein the copolymer is selected from the group consisting of formulae (III)-(XI): 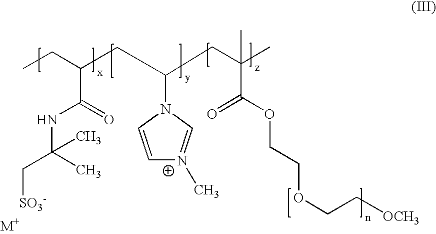
wherein M+ is hydrogen or a water soluble cation such as alkali metals or ammonium; indices x, y, and z of formula (III) are such that the monomer ratio (x:y:z) is from 1:0.5:1 to 1:2:2 and has a weight average molecular weight between 5000 and 10000. 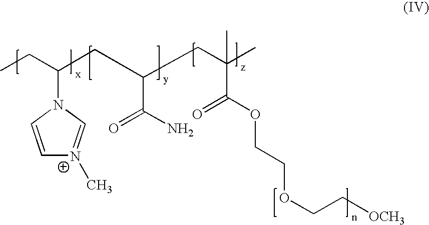
wherein indices x, y, and z of formula (IV) are such that the monomer ratio (x:y:z) is from 1:0.5:1 to 1:1:1 and has a weight average molecular weight between 4000 and 10000. 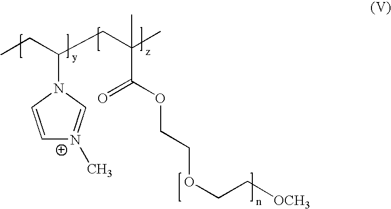
wherein indices y and z of formula (V) are such that the monomer ratio (y:z) is from 1:1 to 1:4 and has a weight average molecular weight between 5000 and 15000. 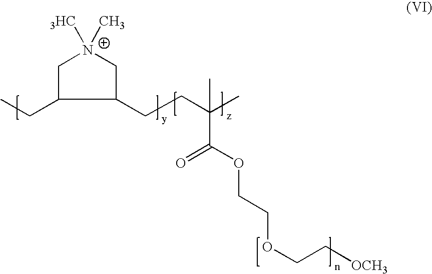
wherein indices y and z of formula (VI) are such that the monomer ratio (y:z) is from 1:1 to 1:4 and has a weight average molecular weight between 5000 and 15000. 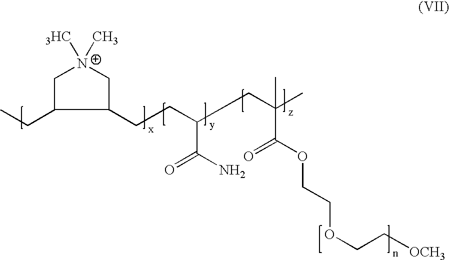
wherein indices x, y, and z of formula (VII) are such that the monomer ratio (x:y:z) is from 1:0.5:1 to 1:1:1 and has a weight average molecular weight between 5000 and 15000. 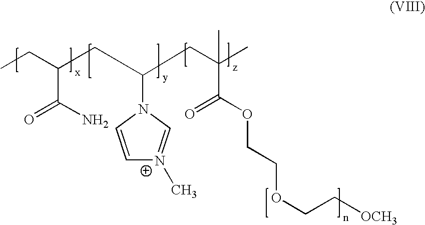
wherein indices x, y, and z of formula (VIII) are such that the monomer ratio (x:y:z) is from 1:1:1 to 10:1:2, including but not limited to 6:1:1, 6:1:2, 10:1:1, and 10:1:2 and has a weight average molecular weight between 10000 and 75000, preferably 10000 or 50000. 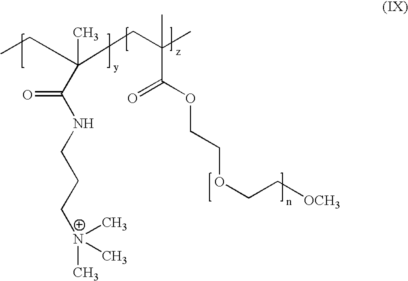
wherein indices y and z of formula (IX) are such that the monomer ratio (y:z) is from 1:1 to 1:2 and has a weight average molecular weight between 4000 and 15000; 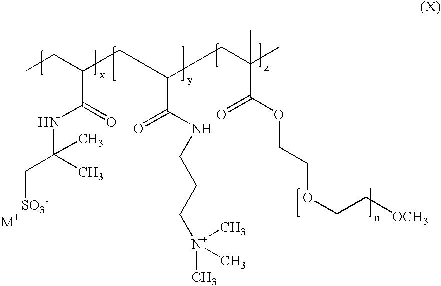
wherein M+ is hydrogen or a water soluble cation such as alkali metals or ammonium; indices x, y, and z of formula (X) are such that the monomer ratio (x:y:z) is from 1:0.5:1 to 1:2:2 and has a weight average molecular weight between 5000 and 15000; 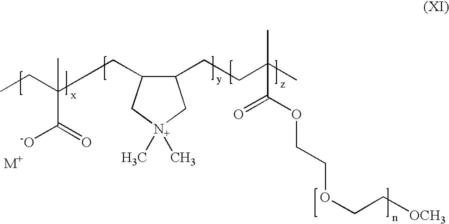
wherein M+ is hydrogen or a water soluble cation such as alkali metals or ammonium; indices x, y, and z of formula (XI) are such that the monomer ratio (x:y:z) is from 1:0.5:1 to 1:2:2 and has a weight average molecular weight between 5000 and 15000.

6. The detergent composition of claim 1 wherein the composition is a laundry detergent composition.

7. The detergent composition of claim 6 wherein the laundry detergent composition is a solid.

8. The detergent composition of claim 6 wherein the laundry detergent composition is a liquid.

9. A method of using the detergent composition of claim 1 for cleaning a surface by contacting the detergent composition of claim 1 with at least a portion of a surface and then rinsing the surface.

10. The detergent composition of claim 1 wherein the composition is a hard surface detergent composition.

11. The detergent composition of claim 10 wherein the hard surface detergent composition impregnates a nonwoven substrate.

12. A method of using the detergent composition of claim 1 for cleaning a surface by contacting a nonwoven substrate impregnated the detergent composition of claim 1 and contacting the nonwoven substrate with at least a portion of a surface.
